(19) United States
(12) Patent Application Publication
(10) Pub. No.: US 2014/0269667 A1
(43) Pub. Date: Sep. 18, 2014

(54) METHOD AND APPARATUS FOR DYNAMIC CONFIGURATION OF PACKET PREAMBLES FOR SYNCHRONIZATION-BASED TRANSMISSIONS

(71) Applicant: QUALCOMM INCORPORATED, San Diego, CA (US)

(72) Inventors: Edward Harrison Teague, San Diego, CA (US); Qingjiang Tian, San Diego, CA (US); Gene Wesley Marsh, Encinitas, CA (US); Arumugam Chendamarai Kannan, San Diego, CA (US)

(73) Assignee: QUALCOMM Incorporated, San Diego, CA (US)

(21) Appl. No.: 13/833,423

(22) Filed: Mar. 15, 2013

(51) Int. Cl. H04W 56/00

(52) U.S. Cl. CPC H04W 56/0065
USPC 370/350

(57) ABSTRACT

Various aspects of the disclosed approach described herein allows a reduction of preamble overhead by tailoring transmitted packet preambles based on an expected level of clock-related offset between a transmitter and a receiver for a pair of communicating nodes. An estimate may be maintained at the transmitter of maximum time and frequency offsets between the transmitter and the receiver. The estimate may then be utilized to create a customized preamble sequence for generating the packet preamble. The estimate may also be utilized to select a particular modulation technique for the packet preamble.

### BACKGROUND

1. Field

Aspects of the present disclosure relate generally to wireless communication systems, and more particularly, to a method and apparatus for dynamic configuration of packet preambles for synchronization-based transmissions.

2. Background

Wireless communications technology has penetrated nearly every aspect of a person's daily routine. Integrated into almost every conceivable electronic device to facilitate business activities as well as personal uses such as entertainment, medicine, and exercise, wireless systems are widely deployed to provide various types of communication content such as voice, data, video, and so on. One type of wireless system technology, referred to as a wireless personal area network (WPAN) provides a wireless communication network for interconnecting devices locally around an individual person. For example, WPAN technology may serve to interconnect the now ubiquitous cell phone with other electronic and communication devices that many people may encounter at their work place, such as printers, scanners, copiers, “wired” multi-line telephone sets, keyboards, mice, etc.; or during personal activities such as exercising, shopping, or dining, such as exercise machines, cash registers, cycling speedometers/odometers, pedometers, automated menu systems, etc. WPAN technology may even serve a more specialized purpose, such as in health care, where wireless sensors may be placed on or near a patient to allow medical professionals to monitor that patient—whether that patient is actually in a medical care facility such as a hospital or remotely through the use of a cell phone or other wireless communication device carried around by that patient.

In order for devices to wirelessly communicate data with each other, they most be able to synchronize their timing. One way these devices may achieve synchronization is through transmission of predefined sets of signals preceding each communication of data payload between the devices. For example, each transmission of a data payload by a transmitting device may be preceded by a sequence of alternating 1's and 0's. The sequence, generally referred to as a preamble sequence—or simply a preamble where one or more repetitions of a particular preamble are transmitted, is typically placed in a predetermined structure that includes the data payload. The preamble allows a receiving device to synchronize its local clock with that of the transmitting device. Through use of specific preamble sequence assignments to each device, the preamble sequence may also allow identification of a transmitter of the preamble, such as the transmitting device. Accordingly, the preamble sequence may further also allow the identification of a recipient, such as the receiving device, for which a packet payload accompanying the preamble is intended.

In a typical WPAN, many times communicating nodes may only transmit packets occasionally. As such, any time reference between a pair of communicating nodes may drift from one packet transmission to another because clocks of the communicating nodes may not keep perfect time due to such causes as variation of manufacture or design of these clocks, as well as environmental differences such as temperature. Thus, an initial synchronization acquired by the pair of communicating nodes as maintained by these clocks may slowly be lost in a phenomenon referred to as clock drift. Further preamble transmissions may enable a receiver of a packet to resynchronize the time reference and recover from clock drift prior to the receiver demodulating any data payload that may accompanying the preamble sequence in the packet. Because synchronization may have been lost or may be undependable, it is typically necessary to reacquire synchronization using the complete preamble. Assuming that there is no timing knowledge at the receiver, typical required preambles can be very long and these large preambles contribute to significant overhead in the system.

In order to be able to support reacquisition of synchronization while reducing overhead, other approaches are desired.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the disclosed approach provides a method for optimizing preamble overhead by dynamically generating packet preambles as a function of estimated time and frequency offsets between a transmitter and receiver in a WPAN system. These offsets may be referred to herein as “clock-offsets,” and in one aspect of the disclosed approach the packet preamble may be customized in length. In another aspect of the disclosed approach, the modulation of the packet preamble may be customized.

In one aspect, the disclosure provides a method for wireless communication including determining an estimate of a clock-related offset between a transmitter and a receiver based on determined clock stability information; generating a packet preamble based on the estimate of the clock-related offset; and transmitting the packet preamble to the receiver.

Another aspect of the disclosure provides an apparatus for wireless communication that includes means for determining an estimate of a clock-related offset between a transmitter and a receiver based on determined clock stability information; means for generating a packet preamble based on the estimate of the clock-related offset; and means for transmitting the packet preamble to the receiver.

Yet another aspect of the disclosure provides a computer program product that includes a computer-readable storage medium having code executable by a processing system for determining an estimate of a clock-related offset between a transmitter and a receiver based on determined clock stability information; generating a packet preamble based on the estimate of the clock-related offset; and transmitting the packet preamble to the receiver.

Still yet another aspect of the disclosure provides an apparatus for wireless communication that includes at least one processor and a memory coupled to the at least one processor and configured to cause the at least one processor to determine an estimate of a clock-related offset between a transmitter and a receiver based on determined clock stability information; generate a packet preamble based on the estimate of the clock-related offset; and transmit the packet preamble to the receiver.

These and other aspects of the invention will become more fully understood upon a review of the detailed description, which follows.

### BRIEF DESCRIPTION OF THE DRAWINGS

These and other sample aspects of the disclosure will be described in the detailed description that follow, and in the accompanying drawings.

FIG. 1 is a block diagram conceptually illustrating an example of a communication scenario to which various aspects of an approach for dynamic packet preamble configuration based on clock-related offset may be applied.

FIG. 2 is a flow diagram illustrating a dynamic packet preamble configuration process configured to operate in accordance with various aspects of the disclosed approach for dynamic packet preamble configuration.

FIG. 3 is a block diagram of a dynamic packet preamble configuration system configured in accordance with various aspects of the disclosed approach that may be used with the dynamic packet preamble configuration process of FIG. 2.

FIG. 4 is a block diagram of a random number generator that may be used to generate preamble sequences for dynamic packet preamble configuration in accordance with various aspects of the disclosed approach.

FIG. 5 is a block diagram illustrating an example of a hardware implementation for an apparatus employing a processing system configured in accordance with various aspects of the dynamic packet preamble configuration approach described herein.

FIG. 6 is a flow diagram illustrating a wireless communication process configured to use packet preambles that are dynamically configured in accordance with various aspects of the disclosed dynamic packet preamble configuration approach.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the disclosed approach for dynamic configuration of a packet preamble provide a reduction of preamble overhead by tailoring transmitted packet preambles based on expected levels of timing-related offsets that may occur during communication between wireless devices, or nodes, of a wireless communication system.

For example, each wireless device in a pair of wireless devices may have a clock that is susceptible to a rate of drift. A maximum rate of drift, which is typically specific to each clock, may be determined. Based on this knowledge, a relative time offset between the pair of wireless devices may be estimated at any point in time after an initial synchronization of their clocks. In other words, after an event that allows the pair of wireless devices to synchronize their clocks—such as a packet reception or other communication event, the clocks of each wireless device will drift from this synchronization at a known, respective rate. A relative time offset may thus be determined based on a function that takes these rates into account. Although this relative time offset often grows as a function of time because each clock typically has a different rate of drift, it is often still relatively limited by the amount of time that a transmitter in one of the wireless devices is ready to send another packet.

In one aspect of the disclosed approach, a transmitter in one wireless device may customize a packet preamble in a manner that enables detection and demodulation of that packet preamble at a receiver of another wireless device while jointly optimizing preamble overhead and receiver complexity. An estimate of time offsets for a pair of wireless devices may be used to dynamically configure and optimize the packet preamble used for resynchronization between the pair of wireless devices. For example, a shorter packet preamble may be used if the time offset is estimated to be small. The disclosed approach is different from typical radio systems that operate with a single preamble format. These radio systems may suffer from significant overhead and/or receiver complexity penalties because they are not configured to adjust packet preambles based on timing information.

FIG. 1 illustrates sample aspects of a communications scenario 100 where a first wireless device 110 may acquire synchronization with a second wireless device 140 to synchronize a clock 118 on the first wireless device 110 with a clock 148 of the second wireless device 140. In order to acquire synchronization, in one aspect of the disclosed approach the first wireless 110 may first establish communication with the second wireless device 140 by first generating and then transmitting a preamble signal. The preamble signal may be embodied in a packet preamble that includes one or more preamble sequences. As further described herein, the first wireless device 110 may dynamically configure the packet preamble by utilizing a customized preamble sequence. The customized preamble sequence may be selected by the first wireless device 110 using a packet preamble configuration module 112 in a manner configured as discussed herein. The first wireless device 110 may transmit the packet preamble to the second wireless device 140 to establish synchronization via a wireless transceiver 116. The wireless transceiver 116 may be configured as a transceiver such as an ultra-wideband (UWB)-capable transceiver. It should be noted that although the clock 118 is illustrated as being coupled to the wireless transceiver 116 of the first wireless device 110, and the clock 148 is coupled to the wireless transceiver 142 of the second wireless device 140, the specific configuration and coupling of the clocks may be determined by a particular application.

In addition to establishing an initial synchronization with the second wireless device 140, the first wireless device 110 may also need to reacquire synchronization with the second wireless device 140 in certain circumstances. For example, a period of time may have elapsed since a previous communication between the two devices. During this period of time, timing-related offsets for the clock 118 and the clock 148 as described above may negatively affect communication between the devices if not addressed. In one aspect of the disclosed approach, to reacquire synchronization the first wireless device 110 may dynamically configure another packet preamble using the same or another one of the generated preamble sequences. Preferably, the first wireless device 110 may use a shorter length preamble sequence during the reacquisition process than the packet preamble used during the initial synchronization process. In another aspect of the disclosed approach, to reacquire synchronization the first wireless device 110 may use a different packet preamble modulation technique than the one originally used for modulating the packet preamble of the initial acquisition process.

In accordance with various aspects of the disclosed approach, dynamic configuration of the packet preamble may be based on an estimate of timing-related offsets between a clock at a transmitter such as the clock 118 at the first wireless device 110 and a clock at a receiver such as the clock 148 at the second wireless device 140. For example, in one aspect of the disclosed approach the estimate of timing-related offsets may be used to select a preamble sequence for generating the packet preamble. In another aspect of the disclosed approach, a particular modulation technique for modulating the packet preamble may be selected dynamically based on the estimate of timing-related offsets. These timing-related offsets, which may also be referred to as “clock-related offsets” herein, may be defined as mismatches or offsets between the wireless devices in timing or frequency that occur between synchronization events. The mismatches or offsets may be due to clock drift, as described above. Clock drift may be due to clock skew caused by process variation during manufacturing of timing components of the clock 118 of the first wireless device 110 and the clock 148 of the second wireless device 140, respectively. Further, environmental parameters such as operating temperature or power fluctuation may also cause mismatches or offsets. In general, time-related offsets may be associated with clock drifts, frequency drifts, phase drifts, synchronization drifts, or any other effect where a parameter that was synchronized by a communication such as a preamble transmission between two devices has changed over time. For example, a particular estimate of a clock-related offset between a first node and a second node may be due to a clock drift. The magnitude of the estimate may be proportional to an amount of time that has elapsed since a previous communication between the first node and the second node where, during the previous communication, clocks for the first node and the second node were synchronized.

In the example illustrated in FIG. 1, estimates of a clock-related offset may be determined and maintained by the first wireless device 110 in a clock-related offset determination module 114. In one aspect, the clock-related offset determination module 114 may determine an estimate of the clock-related offset by determining an elapsed period of time from a previous communication between the transmitter and the receiver. As disclosed above, the first wireless device 110 includes the clock 118 configured to be synchronized with timing information from the receiver during the previous communication. Further, as part of its determination of the estimate of the clock-related offset, the clock-related offset determination module 114 may estimate an amount of drift between the clock of the transmitter and the timing information from the receiver during the elapsed period of time. Preferably, the determined clock stability information comprises clock accuracy information for the receiver that is known by the transmitter, and the clock-related offset determination module 114 may calculate a maximum drift that could occur during the elapsed period of time based on the clock accuracy information for the receiver when the clock-related offset determination module 114 estimates the amount of drift.

In addition to communicating with the second wireless device 140, the first wireless device 110 may also have to communicate with other wireless devices, an example of which is illustrated in FIG. 1 as a third wireless device 160 having a wireless transceiver 162. In one aspect of the disclosed approach, the first wireless device 110 may use the packet preamble configuration module 112 to generate another packet preamble for synchronizing the clock 118 with a clock 168 of the third wireless device 160 in a manner similar to the various aspects of the disclosed approach for the second wireless device 140. Accordingly, each of the second and third wireless devices 140 and 160 may acquire a respective preamble signal transmitted from the first wireless device 110 to establish or re-establish timing synchronization and communication with the first wireless device 110. In one aspect of the disclosed approach, to acquire the preamble signal sent from the first wireless device 110, the second and third wireless devices 140 and 160 respectively include sequence detectors 144 and 164 that may detect preamble sequences, which may be of variable lengths. The second and third wireless devices 140 and 160 also respectively include data sinks 146 and 166 to receive information once a communication link has been established with the first wireless device 110. Further, although not shown herein to avoid unnecessarily complicating the description of various aspects of the disclosed approach, each of the second and third wireless devices 140 and 160 may also include a packet preamble configuration module that may be used to dynamically generate packet preambles to synchronize and communicate with the first wireless device 110, each other, and other wireless devices.

The elements illustrated in the communication scenario 100 may be implemented in different ways in different applications. For example, the various aspects of the approach described herein may be implemented in a system where components are attached to one another (e.g., where components are interconnected by wires) or in a system where components are detached from one another (e.g., a wireless system). Also, the various aspects of the approach herein may be employed in conjunction with processing of various types of information. For example, in some implementations this information may comprise control information that may be used to control certain operations at different components. In some implementations this information may comprise data such as audio data, video data, sensor data, or gaming data.

Various well-known methods and elements may be implemented for communicating between the first wireless device 110 and the second and third wireless devices 140 and 160, and unless otherwise noted, no further description will be provided herein as to these methods and elements so as to allow the various aspects of the disclosed approach to be more thoroughly discussed.

FIG. 2 illustrates a dynamic packet preamble configuration process 200 configured for generating and using packet preambles that may be implemented in a dynamic packet preamble configuration system 300, as shown in FIG. 3, that includes a packet preamble configuration module 310 and a clock-related offset determination module 330. Various aspects of the disclosed approach described herein allow a reduction of preamble overhead by tailoring transmitted packet preambles based on an expected level of clock-related offset between a transmitter such as the first wireless device 110 and a receiver such as the second wireless device 140. The tailored packet preambles may be used to reacquire synchronization between the first wireless device 110 and the second wireless device 140, such as when a certain amount of time elapses after a previous synchronization. The clock-related offset determination module 330 may be used to determine an estimate of a timing-related offset that may be used to select a variable length preamble sequence (VLPS) generated by a VLPS generation module 312 in the packet preamble configuration module 310 and stored in a VLPS storage module 314, with the selection being performed by a VLPS selection module 316. The estimate may also be used to select a modulation scheme by a packet preamble modulation selection module 318. The packet preamble may be created by a packet preamble generation module 320.

At 202, in one aspect of the disclosed approach timing synchronization information may be acquired by a transmission of a packet from the transmitter to the receiver to correct any clock-related offsets of their respective timing circuits. For example, the first wireless device 110 may transmit a packet with a first preamble sequence to the second wireless device 140, and it may be assumed that any clock-offsets will have been corrected after a successful packet decode by the sequence detector 144 of the second wireless device 140. Thus, the clock-related offset determination module 330 may receive an SYNC_INIT signal confirming that a packet preamble such as that transmitted in an initial packet has been correctly decoded. The SYNC_INIT signal may be generated by a transceiver such as the wireless transceiver 116 after an acknowledgement has been received by the wireless transceiver 116 that the second wireless device 140 has correctly received and decoded the initial packet.

In addition to receiving the SYNC_INIT signal, the clock-related offset determination module 330 may also receive clock information including local clock information, labeled as “CLK_LOCAL”, and clock information for a remote node such as the receiver, or the second wireless node 140, labeled as “CLK_OTHER”. The clock information may include clock drift information and other timing-related information.

At 204, it is determined if a new packet is being transmitted by the first wireless device 110. If so, then operation may continue at 206. Otherwise, the first wireless device 110 may operate normally, such as wait for a new packet to be transmitted or receipt of a communication from another wireless device.

At 206, when a new packet is to be transmitted, the first wireless device 110 may estimate a clock-related offset using the clock-related offset determination module 330. In one aspect of the disclosed approach, the first wireless device 110 may use known rates of drift of timing circuits at the transmitter and receiver to estimate these clock-related offsets. The first wireless device 110 may acquire clock drift information from the second wireless device 140 during the timing synchronization information acquisition at 202. These clock-related offsets may vary as a function of time, and increase proportionally based on the period of time that has transpired since a previous transmission.

For example, if a new packet is ready to be transmitted shortly after a previously successful packet transmission, these offsets may be small. However, if the new packet is ready to be transmitted after a longer time, then it is expected that drift will result in larger clock-related offsets.

In one aspect of the disclosed approach, an estimate of the clock-related offset, including maximum time and frequency offsets between the transmitter and the receiver may be maintained at the transmitter. For example, the estimate may be stored in the clock-related offset estimation module 330. These maximum time and frequency offsets may be used to select a variable length preamble sequence for creating the packet preamble.

At 208, a preamble sequence may be selected by the VLPS selection module 316 based on the estimated clock-related offset determined by the clock-related offset determination module 330 at 206. In one aspect of the disclosed approach, the selected preamble sequence may be a preamble sequence created by the packet preamble configuration module 112. Referring to FIG. 3, the selected preamble sequence may be a variable length preamble sequence created by the VLPS generation module 312 in the packet preamble configuration module 310.

In another aspect of the disclosed approach, the selected preamble sequence may be chosen from a set of variable length preamble sequences generated by the VLPS generation module 312 specifically for the second wireless device 140. The set of variable length preamble sequences may be stored in the VLPS storage module 314 of the packet preamble configuration module 310.

In yet another aspect of the disclosed approach, the first wireless device 110 may use a preamble sequence from an existing set of variable length preamble sequences for the selected preamble sequence. In this case, wireless devices may share preamble sequences from one set of variable length preamble sequences that are stored in the VLPS storage module 314. Although possible, this approach may not be preferable because of the possibility of wireless devices using the same preamble sequence.

The various examples provided herein for the selected preamble sequence are directed to variable length preamble sequences. However, it should be noted that other than varying a length of the selected preamble sequence, it may be possible to more dramatically change a format of the preamble sequence. For example, some preamble sequences require that a receiver either has knowledge of or may guess a starting point, referred to herein as a start-of-sequence hypothesis, in the preamble sequence. Thus, the receiver must be able to correctly guess the starting point, such as by using multiple hypotheses decoding for example, to detect the preamble. For this type of preamble, it is important that the receiver has a fairly accurate timing synchronization to limit the number of possible starting time guesses. Otherwise, the number of sequence starting time hypotheses would be prohibitively large and result in unacceptable receiver complexity. However, this type of preamble may be designed to be quite efficient in terms of a sequence length required for detection because shorter lengths may be used based on some knowledge of timing information.

Alternatively, some preambles may enable detection without need for a start time assumption. These preambles typically have cyclic character that may be detected regardless of a decode start time. However, these preambles require more energy and must typically be longer in length for detection.

In these various aspects of the disclosed approach, regardless of whether any new preamble sequences are generated for the selected preamble sequence, it is preferable that a preamble sequence used for the second wireless device 140 not be identical to a preamble sequence used for the third wireless device 160. If may be even more preferable that any preamble sequences used for synchronization or reacquisition between the first wireless device 110 and the second wireless device 140 be different from any preamble sequences used for synchronization or reacquisition between the first wireless device 110 and the third wireless device 160. The use of different preamble sequences allows other wireless devices to differentiate between transmissions sent from the first wireless device 110. With appropriately configured characteristics of the preamble sequences, orthogonality between the transmissions of the different wireless devices may be enhanced, thereby reducing interference.

At 210, the packet preamble may be generated based on the selected preamble sequence by the packet preamble generation module 320. In one aspect of the disclosed approach, the selected preamble sequence may be used to create a preamble for use as the packet preamble, where the selected preamble sequence may be prepended before other data at a specific position in a packet structure. For example, where the preamble sequence has a cyclic nature, the preamble may include multiple copies of the preamble sequence.

At 212, the packet preamble modulation selection module 318 may be used to select a modulation scheme for modulating the packet preamble. Example modulation schemes include such basic modulation schemes as amplitude modulation (AM), frequency modulation (FM), discrete multi-tone modulation (DMT), and more sophisticated modulation schemes including phase-shift keying (PSK), pulse-position modulation (PPM), and orthogonal frequency-division multiplexing (OFDM). In one aspect of the disclosed approach, a simpler modulation scheme may be used with shorter packet preambles as well as those transmissions that need to be less robust. In another aspect of the disclosed approach, instead of selecting a different modulation scheme, an existing modulation scheme may be modified with less complexity, such as reducing one or more parameters of the modulation. For example, a PSK scheme may be configured with fewer phases.

FIG. 4 illustrates a random number generator 400 that may be used in accordance with various aspects of the dynamic packet preamble configuration process 200 described herein. In one aspect of the disclosed approach, the random number generator 400 is implemented using a linear feedback shift register (LFSR) 402, as illustrated in FIG. 4 as an n-bit LFSR that includes an n-bit register block 420. The LFSR 402 may be used to generate pseudorandom values to be used by the VLPS generation module 312 of FIG. 3 to generate desired preamble sequences in accordance with various aspects of the disclosed approach.

A LFSR is a shift register whose output is a linear function of its previous state and, as illustrated, an output of the LFSR 402 is based on results received from an XOR function, implemented as an XOR gate 410 that receives inputs from the n-bit register block 420 with bits a[1]-a[n]. Because in an LFSR only some bits of the overall shift register value may be used in the XOR function, only a particular subset of the total number of registers in the n-bit register block 420 may be coupled to the XOR gate 410. This subset may be defined, where n=72, by a primitive sequence formula as shown below:

Primitive Sequence=x⁷²+x⁶⁸+x⁶⁵+x⁶³+x⁶²+x⁵⁹+x⁵⁶+x⁵⁵+x⁵²+x⁴⁵+x⁴³+x⁴¹+x⁴⁰+x³⁹+x³⁷+x³⁶+x³⁵+x³¹+x³⁰+x²⁷+x²⁴++x²³+x¹⁸+x¹⁵+x¹³+x¹¹+x¹⁰+x⁸+x⁷+x⁵+x⁴+x³+x²+x¹,

where {xᵢ} may represent a connection to XOR gate 410 of a register at an index i in the n-bit register block 420, and:

iε{1,2,3,4,5,7,8,10,11,13,15,18,23,24,27,30,31,35,36,37,39,40,41,43,45,52,55,56,59,62,63,65,68,72}.

The LFSR 402 may be initialized by using a particular set of values in the n-bit register 420, referred to as a seed and illustrated as being received in a “SEED” input in the figure. In one aspect of the disclosed approach, the seed may be shared between two wireless devices so that each of them may generate the same random values to be used to produce an identical set of variable length preamble sequences. For example, the first and second wireless devices 110 and 140 may share a first seed so that each of them may generate a first set of variable length preamble sequences. The first and third wireless devices 110 and 160 may share a second seed different from the first seed so that each of them may generate a second, different set of variable length preamble sequences. In accordance with various aspects of the disclosed approach, the seeds may be pre-shared and a selection process may be used to minimize or eliminate a duplicate seed being used by wireless devices in a communication scheme, such as the second and third wireless devices 140 and 160 using the same seed for communicating with the first wireless device 110.

In various aspects of the disclosed approach, because a receiver such as the second wireless device 140 knows the common seed, the exact same sequences may be generated at the receiver in order to perform sequence detection. A typical process of detecting such sequences may be based on an energy accumulation approach. For example, in a binary case (i.e., a two symbol set consisting of zeros and ones), acquisition may be based on energy accumulation to determine energy in the zeros and energy in the ones. The receiver may thus accumulate the energy in all locations that it expects a one, and all other locations where it expects a zero for different possible sequence hypotheses. The hypothesis that yields the maximum energy in both zeros and ones is declared the winning candidate. Acquisition of a sequence may be expedited if the receiver has a more accurate prediction of where to search for the sequences. In one aspect of the disclosed approach, the receiver may create a sequence hypothesis referred to as a start-of-sequence hypothesis based on an estimate of the clock-related offset as discussed above. For example, if the receiver is able to determine, with some certainty, a potential start for the transmitted sequence from the transmitter, then the receiver may search for the sequence in a smaller range, thereby reducing receiver complexity and resource use.

A wireless node such as any one of the wireless devices described herein may include various components that perform functions based on signals (e.g., comprising information such as data) that are transmitted by or received at the wireless node (e.g., via a transmitter or receiver). For example, a wireless headset may include a transducer configured to provide an audio output based on the information or provide an audio output that associated with (e.g., based on or used to control transmission of) data that is transmitted in conjunction with a synchronization signal. A wireless watch may include a user interface configured to provide an indication based on the information or provide an indication that associated with (e.g., based on or used to control transmission of) data that is transmitted in conjunction with a synchronization signal. A wireless sensing device may include a sensor configured to sense based on the information (e.g., based on a request included in the information) or configured to provide data that is transmitted in conjunction with a synchronization signal.

A wireless node such as any one of the wireless devices described herein may communicate via one or more wireless communication links that are based on or otherwise support any suitable wireless communication technology. For example, in some aspects of the disclosed approach, a wireless node may associate with a network. In some aspects the network may comprise a personal area network (e.g., supporting a wireless coverage area on the order of 30 meters) or a body area network (e.g., supporting a wireless coverage area on the order of 10 meters) implemented using ultra-wideband technology or some other suitable technology. In some aspects the network may comprise a local area network or a wide area network. A wireless node may support or otherwise use one or more of a variety of wireless communication technologies, protocols, or standards such as, for example, CDMA, TDMA, OFDM, OFDMA, WiMAX and Wi-Fi. Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

In some aspects, a wireless node such as one of the wireless devices described herein may communicate via an impulse-based wireless communication link. For example, an impulse-based wireless communication link may utilize ultra-wideband pulses that have a relatively short length (e.g., on the order of a few nanoseconds or less) and a relatively wide bandwidth. The ultra-wideband pulses may have a fractional bandwidth on the order of approximately 20% or more and/or have a bandwidth on the order of approximately 500 MHz or more.

The teachings herein may be incorporated into (e.g., implemented within or performed by) a variety of apparatuses (e.g., devices). For example, one or more aspects taught herein may be incorporated into a phone (e.g. a cellular phone), a personal data assistant (“PDA”), an entertainment device (e.g., a music or video device), a headset (e.g., headphones, an earpiece, etc.), a microphone, a medical sensing device (e.g., a biometric sensor, a heart rate monitor, a pedometer, an EKG device, a smart bandage, etc.), a user I/O device (e.g., a watch, a remote control, a light switch, a keyboard, a mouse, etc.), an environment sensing device (e.g., a tire pressure monitor), a computer, a point-of-sale device, an entertainment device, a hearing aid, a set-top box, or any other suitable device.

These devices may have different power and data requirements. In some aspects, the teachings herein may be adapted for use in low power applications (e.g., through the use of an impulse-based signaling scheme and low duty cycle modes) and may support a variety of data rates including relatively high data rates (e.g., through the use of high-bandwidth pulses).

In some aspects, a wireless node such as one of the wireless devices described herein may comprise an access device (e.g., an access point) for a communication system. Such an access device may provide, for example, connectivity to another network (e.g., a wide area network such as the Internet or a cellular network) via a wired or wireless communication link. Accordingly, the access device may enable another device (e.g., a wireless station) to access the other network or some other functionality. In addition, it should be appreciated that one or both of the devices may be portable or, in some cases, relatively non-portable. Also, it should be appreciated that a wireless node also may be capable of transmitting and/or receiving information in a non-wireless manner (e.g., via a wired connection) via an appropriate communication interface.

FIG. 5 is a conceptual diagram illustrating an example of a hardware implementation for an apparatus 500 employing a processing system 510 that may be used in accordance with various aspects of the disclosed approach for dynamic configuration of packet preambles. Thus, in accordance with various aspects of the disclosure, an element, or any portion of an element, or any combination of elements for dynamic configuration of packet preamble and use thereof in a communication protocol, including a wireless node, may be implemented with the processing system 510.

The processing system 510 includes a packet preamble configuration module 530 that may be configured in accordance with various aspects of the disclosed approach to generate, store, and/or use dynamically configured packet preambles in combination with other elements in the processing system 510. For example, the processing system 510 includes one or more processors illustrated as a processor 514. Examples of processors 514 include microprocessors, microcontrollers digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processor 514 may be used by the packet preamble configuration module 530 to perform such functions as random number generation in a manner as described for the LFSR 402, as illustrated in FIG. 4. The processor 514 may be used by the packet preamble configuration module 530 to create sets of variable length preamble sequences in a manner as described for the VLPS generation module 312, as illustrated in FIG. 3. Further, the processor 514 may be used by the packet preamble configuration module 530 to select preamble sequences in a manner as described for the VLPS selection module 316, as illustrated in FIG. 3. Further still, the processor 514 may be used by the packet preamble configuration module 530 to select a modulation scheme in a manner as described for the packet preamble modulation selection module and modulate a packet preamble using the selected scheme.

In this example, the processing system 510 may be implemented as having a bus architecture, represented generally by a bus 512. The bus 512 may include any number of interconnecting buses and bridges depending on the specific application of the processing system 510 and overall design constraints. The bus 512 links together various circuits including the packet preamble configuration module 530, one or more processors (represented generally by the processor 514), a memory 518, and computer-readable media (represented generally by a computer-readable medium 516). The bus 512 may also link various other circuits such as timing sources, peripherals, voltage regulators, and power management circuits, which are well known in the art, and therefore, will not be described any further. A bus interface 520 provides an interface between the bus 512 and a transceiver 550. The transceiver 550 provides a means for communicating with various other apparatus over a transmission medium. Depending upon the nature of the apparatus, a user interface 540 (e.g., keypad, display, speaker, microphone, joystick) may also be provided.

The processor 514 is responsible for managing the bus 512 and general processing, including execution of software that may be stored on the computer-readable medium 516 or the memory 518. The software, when executed by the processor 514, causes the processing system 510 to perform the various functions described herein for any particular apparatus. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The computer-readable medium 516 or the memory 518 may also be used for storing data that is manipulated by the processor 514 when executing software. For example, this data may include generated variable length preamble sequences and packet preambles as well as any created packet structures. This data may also include any variables or temporary storage values needed for operation of the processing system 500, including any temporary storage needed to create the variable length packet preambles and modulation of the packet preambles.

The computer-readable medium 516 may be a non-transitory computer-readable medium such as a computer-readable storage medium. A non-transitory computer-readable medium includes, by way of example, a magnetic storage device (e.g., hard disk, floppy disk, magnetic strip), an optical disk (e.g. a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. Although illustrated as residing in the processing system 510, the computer-readable medium 516 may reside externally to the processing system 510, or distributed across multiple entities including the processing system 510. The computer-readable medium 516 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one configuration, wireless nodes for wireless communication such as the first, second, and third wireless devices 110, 140, and 160 includes means for determining an estimate of clock-related offsets between a transmitter and a receiver based on determined clock stability information; means for generating a packet preamble based on the estimate of clock-related offsets; and means for transmitting the packet preamble to the receiver. In one aspect of the disclosed approach, the aforementioned means may include the clock-related offset estimation module 330 for estimating a timing-offset. The means for generating a packet preamble based on the estimate of clock-related offsets may include the packet preamble generation module 320. The means for transmitting the packet preamble to the receiver may include the transceiver 550 in the processing system 510 of FIG. 5. Further, one or more processors in the processing system 510 may be configured as means for performing the functions recited by the aforementioned means. In yet another aspect, the aforementioned means may be a module or any apparatus configured to perform the functions recited by the aforementioned means.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunct on with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

Various aspects of the disclosed approach described herein allows a reduction of preamble overhead by tailoring transmitted packet preambles based on an expected level of clock-related offset between a transmitter and a receiver for a pair of communicating nodes. Clock-related offsets may include time and/or frequency offsets between the communicating nodes. In one aspect of the disclosed approach, an estimate may be maintained at the transmitter of maximum time and/or frequency offsets between the transmitter and the receiver. The estimate may then be utilized to create a customized preamble sequence for generating the packet preamble. The customized preamble sequence used for generating the customized packet preamble may also be selected from a set of pre-generated preamble sequences, where each preamble sequence in the set of pre-generated sequences may have a different variable preamble sequence characteristic. In one aspect of the disclosed approach, the variable preamble sequence characteristic may include a preamble sequence length optimized for a particular expected timing offset. In addition to the preamble sequence length, a particular modulation technique may be chosen based on the estimate of maximum time and frequency offsets to modulate the packet preamble.

The packet preamble is tailored in a way that enables detection and demodulation at the receiver while jointly optimizing preamble overhead and receiver complexity. Thus, in contrast to other approaches, which typically just support a single preamble type that is intended to enable a receiver to synchronize timing with a transmitter regardless of an amount of clock-related offset, various aspects of the disclosed approach allow a pair of communicating nodes to synchronize timing using, based on estimated clock-related offsets, packet preambles having variable packet sequence characteristics and/or different modulation techniques. Consequently, both preamble transmission and synchronization overhead may be reduced, and overall system efficiency may be increased.

As an example of some of the various aspects of the disclosed approach, FIG. 6 illustrates a wireless communication process 600 that may be configured to use packet preambles that are created using the disclosed approach where, at 602, an estimate of clock-related offsets between a transmitter and a receiver is generated based on determined clock stability information. In accordance with various aspects of the disclosed approach, a determination of the estimate of clock-related offsets may include determining a timing difference between a previous transmission and a current transmission. The timing difference may be based on clock drift, frequency offset, and/or timing offset. After any clock-related offsets have been estimated then, at 604, a packet preamble may be generated based on the estimate of clock-related offsets. In one aspect of the disclosed approach, the generation of the packet preamble includes generating a set of preamble sequences, wherein each preamble sequence in the set of preamble sequences includes a variable preamble sequence characteristic. A preamble sequence may then be selected from the set of preamble sequences based on the estimate of clock-related offsets and the timing difference, where the selected preamble sequence comprises a desired variable preamble sequence characteristic that is associated with the estimate of clock-related offsets and the timing difference, such as a length of preamble sequence. In another aspect of the disclosed approach, the generation of the packet preamble includes selecting a preamble modulation from a set of different modulation techniques based on the estimate of clock-related offsets and the timing difference. Once the packet preamble has been generated then, at 606, the packet preamble is transmitted to the receiver.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Also, it should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Unless specifically stated otherwise, the term “some” refers to one or more. A phrase referring to “at least one of” a list of items refers to any combination of those items, including single members. As an example, “at least one of: A, B, or C” is intended to cover: A; B; C; A and B; A and C; B and C; and A, B and C.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication comprising:
determining an estimate of a clock-related offset between a transmitter and a receiver based on determined clock stability information;
generating a packet preamble based on the estimate of the clock-related offset; and,
transmitting the packet preamble to the receiver.

2. The method of claim 1, wherein the determining the estimate of the clock-related offset comprises determining an elapsed period of time from a previous communication between the transmitter and the receiver.

3. The method of claim 2, wherein the transmitter comprises a clock configured to be synchronized with timing information from the receiver during the previous communication.

4. The method of claim 3, wherein the determining the estimate of the clock-related offset comprises estimating an amount of drift between the clock of the transmitter and the timing information from the receiver during the elapsed period of time.

5. The method of claim 4, wherein the determined clock stability information comprises clock accuracy information for the receiver that is known by the transmitter, and the estimating the amount of drift comprises calculating a maximum drift that could occur during the elapsed period of time based on the clock accuracy information for the receiver.

6. The method of claim 2, wherein the packet preamble comprises a preamble modulation, and the generating the packet preamble comprises selecting the preamble modulation from among a set of different modulation techniques based on the estimate of the clock-related offset.

7. The method of claim 1, wherein the packet preamble comprises a preamble sequence, and the generating the packet preamble comprises determining a length for the preamble sequence based on the estimate of the clock-related offset.

8. The method of claim 7, further comprising:
determining a second estimate of a second clock-related offset between the transmitter and the receiver based on the determined clock stability information;
generating a second packet preamble based on the second estimate of the second clock-related offset; and,
transmitting the second packet preamble.

9. The method of claim 8, wherein the second packet preamble comprises a second preamble sequence, and the generating the second packet preamble comprises determining a second length for the second preamble sequence based on the second estimate of the second clock-related offset.

10. The method of claim 1, wherein the clock-related offset comprises at least one of a clock drift, a frequency drift, a phase drift, and a timing-related difference.

11. The method of claim 1, further comprising determining a start-of-sequence hypothesis at the receiver based on the estimate of the clock-related offset.

12. An apparatus for wireless communication comprising:
means for determining an estimate of a clock-related offset between a transmitter and a receiver based on determined clock stability information;
means for generating a packet preamble based on the estimate of the clock-related offset; and,
means for transmitting the packet preamble to the receiver.

13. The apparatus of claim 12, wherein the means for determining the estimate of the clock-related offset comprises means for determining an elapsed period of time from a previous communication between the transmitter and the receiver.

14. The apparatus of claim 13, wherein the transmitter comprises a clock configured to be synchronized with timing information from the receiver during the previous communication.

15. The apparatus of claim 14, wherein the means for determining the estimate of the clock-related offset comprises means for estimating an amount of drift between the clock of the transmitter and the timing information from the receiver during the elapsed period of time.

16. The apparatus of claim 15, wherein the determined clock stability information comprises clock accuracy information for the receiver that is known by the transmitter, and the means for estimating the amount of drift comprises means for calculating a maximum drift that could occur during the elapsed period of time based on the clock accuracy information for the receiver.

17. The apparatus of claim 13, wherein the packet preamble comprises a preamble modulation, and the means for generating the packet preamble comprises means for selecting the preamble modulation from among a set of different modulation techniques based on the estimate of the clock-related offset.

18. The apparatus of claim 12, wherein the packet preamble comprises a preamble sequence, and the means for generating the packet preamble comprises means for determining a length for the preamble sequence based on the estimate of the clock-related offset.

19. The apparatus of claim 18, further comprising:
means for determining a second estimate of a second clock-related offset between the transmitter and the receiver based on the determined clock stability information;
means for generating a second packet preamble based on the second estimate of the second clock-related offset; and,
means for transmitting the second packet preamble.

20. The apparatus of claim 19, wherein the second packet preamble comprises a second preamble sequence, and the means for generating the second packet preamble comprises determining a second length for the second preamble sequence based on the second estimate of the second clock-related offset.

21. The apparatus of claim 12, wherein the clock-related offset comprises at least one of a clock drift, a frequency drift, a phase drift, and a timing-related difference.

22. The apparatus of claim 12, further comprising means for providing timing information to the receiver, the timing information configured to allow the receiver to determine a start-of-sequence hypothesis.

23. A apparatus for wireless communication comprising:
at least one processor; and
a memory coupled to the at least one processor and configured to cause the at least one processor to:
determine an estimate of a clock-related offset between a transmitter and a receiver based on determined clock stability information;
generate a packet preamble based on the estimate of the clock-related offset; and,
transmit the packet preamble to the receiver.

24. The apparatus of claim 23, wherein the memory is further configured to cause the at least one processor to determine an elapsed period of time from a previous communication between the transmitter and the receiver.

25. The apparatus of claim 24, wherein the transmitter comprises a clock configured to be synchronized with timing information from the receiver during the previous communication.

26. The apparatus of claim 25, wherein the memory is further configured to cause the at least one processor to estimate an amount of drift between the clock of the transmitter and the timing information from the receiver during the elapsed period of time.

27. The apparatus of claim 26, wherein the determined clock stability information comprises clock accuracy information for the receiver that is known by the transmitter, and the memory is further configured to cause the at least one processor to calculate a maximum drift that could occur during the elapsed period of time based on the clock accuracy information for the receiver.

28. The apparatus of claim 24, wherein the packet preamble comprises a preamble modulation, and the memory is further configured to cause the at least one processor to select the preamble modulation from among a set of different modulation techniques based on the estimate of the clock-related offset.

29. The apparatus of claim 23, wherein the packet preamble comprises a preamble sequence, and the memory is further configured to cause the at least one processor to determine a length for the preamble sequence based on the estimate of the clock-related offset.

30. The apparatus of claim 29, wherein the memory is further configured to cause the at least one processor to
determine a second estimate of a second clock-related offset between the transmitter and the receiver based on the determined clock stability information;
generate a second packet preamble based on the second estimate of the second clock-related offset; and,
transmit the second packet preamble.

31. The apparatus of claim 30, wherein the second packet preamble comprises a second preamble sequence, and the memory is further configured to cause the at least one processor to determine a second length for the second preamble sequence based on the second estimate of the second clock-related offset.

32. The apparatus of claim 23, wherein the clock-related offset comprises at least one of a clock drift, a frequency drift, a phase drift, and a timing-related difference.

33. The apparatus of claim 23, wherein the memory is further configured to cause the at least one processor to provide timing information to the receiver, the timing information configured to allow the receiver to determine a start-of-sequence hypothesis.

34. A computer program product, comprising:
a computer-readable storage medium comprising code executable by a processing system for:
determining an estimate of a clock-related offset between a transmitter and a receiver based on determined clock stability information;
generating a packet preamble based on the estimate of the clock-related offset; and,
transmitting the packet preamble to the receiver.

35. The computer program product of claim 34, wherein the code executable by the processing system for determining the estimate of the clock-related offset comprises code executable by the processing system for determining an elapsed period of time from a previous communication between the transmitter and the receiver.

36. The computer program product of claim 35, wherein the transmitter comprises a clock configured to be synchronized with timing information from the receiver during the previous communication.

37. The computer program product of claim 36, wherein the code executable by the processing system for determining the estimate of the clock-related offset comprises code executable by the processing system for estimating an amount of drift between the clock of the transmitter and the timing information from the receiver during the elapsed period of time.

38. The computer program product of claim 37, wherein the determined clock stability information comprises clock accuracy information for the receiver that is known by the transmitter, and the code executable by the processing system for estimating the amount of drift comprises code executable by the processing system for calculating a maximum drift that could occur during the elapsed period of time based on the clock accuracy information for the receiver.

39. The computer program product of claim 35, wherein the packet preamble comprises a preamble modulation, and the code executable by the processing system for generating the packet preamble comprises code executable by the processing system for selecting the preamble modulation from among a set of different modulation techniques based on the estimate of the clock-related offset.

40. The computer program product of claim 34, wherein the packet preamble comprises a preamble sequence, and the code executable by the processing system for generating the packet preamble comprises code executable by the processing system for determining a length for the preamble sequence based on the estimate of the clock-related offset.

41. The computer program product of claim 40, wherein the computer-readable storage medium further comprising code executable by the processing system for:
determining a second estimate of a second clock-related offset between the transmitter and the receiver based on the determined clock stability information;
generating a second packet preamble based on the second estimate of a second clock-related offset; and,
transmitting the second packet preamble.

42. The computer program product of claim 41, wherein the second packet preamble comprises a second preamble sequence, and the code executable by the processing system for generating the second packet preamble comprises code executable by the processing system for determining a second length for the second preamble sequence based on the second estimate of the second clock-related offset.

43. The computer program product of claim 34, wherein the clock-related offset comprises at least one of a clock drift, a frequency drift, a phase drift, and a timing-related difference.

44. The computer program product of claim 34, wherein the computer-readable storage medium further comprising code executable by the processing system for providing timing information to the receiver, the timing information configured to allow the receiver to determine a start-of-sequence hypothesis.
